(19) United States
(12) Patent Application Publication
(10) Pub. No.: US 2020/0158153 A1
(43) Pub. Date: May 21, 2020

(54) Firewood stack retainer

(71) Applicant: Mario Theriault, Fredericton (CA)

(72) Inventor: Mario Theriault, Fredericton (CA)

(21) Appl. No.: 16/602,512

(22) Filed: Oct. 23, 2019

Related U.S. Application Data
(60) Provisional application No. 62/917,020, filed on Nov. 16, 2018.

(51) Int. Cl. F16B 12/50; A47B 81/00; A47B 47/04; F24B 13/00

(52) U.S. Cl. CPC F16B 12/50; F24B 13/00; A47B 47/04; A47B 81/00

(57) ABSTRACT

A firewood stack retainer is used with standard 2×4 lumber to retain a stack of firewood sticks in a neat and tidy arrangement. The retainer is made of a stiff rectangular frame. The longitudinal members have a length similar to a width of a normal stack of firewood. The longitudinal members are spaced apart a distance equivalent to a hypotenuse of a right angle isosceles triangle with sides having a dimension equivalent to a thickness of a standard 2×4 piece of lumber. The rails and posts of the stack are mounted to the retainer in a relaxed fit. A relax tolerance of +10-15% of the hypotenuse, is preferably used so that the posts can lean back and remained in a locked position pending the stacking of firewood sticks on the rails and against the posts.

This patent application claims the benefit of U.S. Provisional Application No. 62/917,020, filed Nov. 16, 2018.

### FIELD OF THE DISCLOSURE

The present invention pertains to devices for retaining pieces of lumber in a right angle relationship, and more particularly, it pertains to retainers for retaining the end posts of a firewood stack at a right angle with the rails under the stack.

### BACKGROUND

A traditional way to stack firewood sticks is to build a box-like structure at each end of the stack, to retain the stack in a rectangular arrangement. This box-like structure is done by placing two sticks of firewood side-by-side, in alignment with the length of the stack. Two more pieces are placed on top of the first two, in a perpendicular alignment with the first two, and so on to build a box-like structure the full height of the stack. However, every stick of firewood is different from another, and not everyone can build such a box-like structure with the required stability. For this reason, basically, there is a market demand for devices to help users to stack firewood sticks in a neat manner.

Some examples of devices for retaining a firewood stack found in the prior art are described below:

U.S. Pat. No. 4,355,725 issued to G. A. Humphrey on Oct. 26, 1982;

This invention consists of a pair of joint devices each comprising a pair of tubular members aligned at a right angle. Each tubular members has inside dimensions to receive a standard 2×4 piece of lumber. When used in a firewood stack, a first pair of 2×4 pieces of lumber constitutes the rails under the stack, and the other two pieces form the posts at the end of the rails.

U.S. Pat. No. 4,616,757 issued to W. S. Hobson on Oct. 14, 1986.

This invention also has a pair of corner bracket to retain pieces of lumber at a right angle, and includes a third piece of lumber between the rails extending transversely, to the stack to stabilize the stack.

U.S. Pat. No. 5,651,467 issued to J. P. Moran, III on Jul. 29, 1997, and U.S. Pat. No. 5,779,063 issued to J. P. Moran, III on Jul. 14, 1998. The device illustrated in these parent and continuation patents also has a pair of brackets, each comprising two cavities at a right angle from each other. A connecting member is permanently connected to the pair of brackets for stabilizing a stack of firewood.

U.S. Pat. No. 6,997,332 issued to D. M. Alexander et al., on Feb. 14, 2006.

The invention described in this document is a metal frame comprising two rails and four posts affixed to each other. In use, firewood sticks are stacked on the rails between the posts.

Considering the devices of the prior art having cavities to receive a 2×4 pieces of lumber with a sliding fit; these devices suffer from the inconvenience that wood exposed to weather swell and twist and get stuck inside the brackets. A structure made with these brackets can hardly be taken apart when the stack of firewood is all consumed.

Moreover, these devices retain the rails with their narrow sides against the ground. An uneven ground under one of the rail makes the stack very unstable and susceptible to topple over. Similarly, a slight twist of one of the rails due to drying of the lumber for example, puts a lean on the stack, and eventually causes the stack to fall over.

Therefore it is believed that a need exists for a stack retainer that is simple to use to build a stack of firewood and easy to take apart after the heating season is over. It is believed that there is a need for a firewood stack retainer that places the rails as far apart as the width of the stack, with the flat side of the rails against the ground.

### SUMMARY

In the present invention, there is provided a firewood stack retainer for use with standard 2×4 lumber posts and rails. This retainer is made of a stiff rectangular frame comprising two spaced-apart parallel longitudinal members and two spaced-apart parallel transverse members. The longitudinal members have a length similar to a width of a normal stack of firewood. The longitudinal members are spaced apart at a distance equivalent to a hypotenuse of a right angle triangle with sides having a dimension equivalent to a thickness of a standard 2×4 piece of lumber. The retainer can be used to retain posts and rails in a double lever-lock joint, using a very relaxed fit between the retainer and the pieces of lumber.

In another aspect, the distance mentioned above is equivalent to the hypotenuse plus a relax tolerance of +10-15% of that hypotenuse, so that the post can lean backward and remained in a locked position pending the stacking of firewood stick on the rails, against the post.

In yet another aspect, there is provided a firewood stack comprising similar-dimensions rail and post and a stiff rectangular retainer retaining said rail and post into a double lock-lever joint, at an angle relative to each other. The strength of this double lock-lever joint is provided by the weight of firewood sticks acting against the rails and posts.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

A preferred embodiment of the method according to the present invention is described with the aid of the accompanying drawings, in which like numerals denote like parts throughout the several views, and in which:

FIG. 1 is a perspective view of a firewood stack having two retainers according the preferred embodiment of the present invention, one at each end of the stack, and one of which has a copy thereof illustrated in a blown-up mode;

FIG. 2 is a perspective view of the preferred firewood stack retainer;

FIG. 3 is a side view of the preferred stack retainer;

FIG. 4 illustrate plan view of the preferred stack retainer;

FIG. 5 illustrates a cross-section view of the preferred retainer as seen along line 5-5 in FIG. 4;

FIG. 6 is a perspective view of a double lock-lever joint made with the preferred stack retainer;

FIG. 7 is a side view of the joint illustrated in FIG. 6;

FIG. 8 is a copy of FIG. 5 explaining the geometry of the preferred firewood stack retainer.

### DETAILED DESCRIPTION OF THE PREFERRED EMBODIMENT

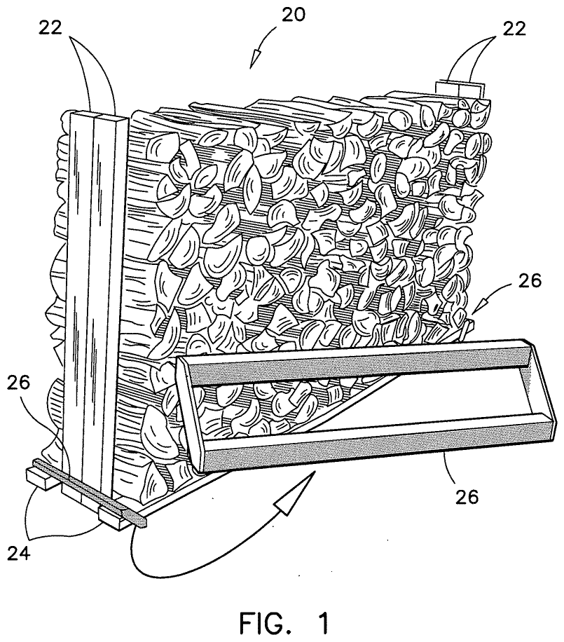

Referring to FIG. 1 a stack 20 of firewood stick is illustrated. The stack 20 is retained in a rectangular arrangement by two posts 22, one at each end, and two rails 24 thereunder. The posts 22 and rails 24 are retained at right angle with each other by two preferred stack retainers 26, one at each end of the rails 24.

The stack 20 has posts 22 and rails 24 made of 2×4 pieces of lumber. The preferred height of the posts is 48 inches, and the preferred solid length of the rails 24 is at least three feet from each end. Higher posts are not recommended, but indefinite length may be used for the rails.

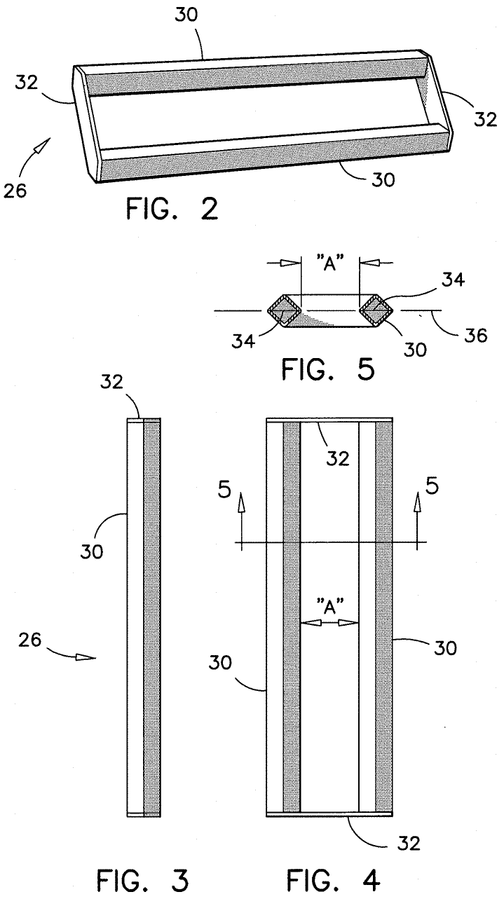

Referring now to FIGS. 2-5, the preferred stack retainer 26 is made of two hollow structural steel (HSS) members 30, with nominal dimensions of 1 inch×1 inch×0.01 inch wall thickness. These two HSS members 30 are retained in a spaced apart relationship by two steel flat bars 32 one at each end of the HSS members 30. The dimensions of these flat bars 32 are 1¼ inch wide by 0.12 inch thick. Although the above dimensions are suggested, other structural materials can be used. The HSS members 30 are preferably affixed to the flat bars 32 by welding, but other methods can also work. The structural materials suggested are stronger than needed. However, the structural members suggested are standard items in stock at most metal retailers and therefore readily available to everyone.

The HSS members 30 are retained together by the flat bars 32 such that the diagonals 34 of the cross-sections of both HSS members 30 align with each other and lie along a same plane 36, as can be seen in FIG. 5. Plane 36 is referred to as the plane of the retainer 26.

The minimum recommended spacing “A” between the HSS member 30 is about 2.12 inches, which is about the hypotenuse of a right angle isosceles triangle with sides “S1”, “S2” having the thickness of a 2×4 piece of lumber, as explained in FIGS. 6, 7 and 8. The lumber dimensions specified herein pertains to planed 2×4 lumber with standard North American Softwood Lumber Dimensions. Both HSS members 30 have a preferred length of 16 inches, which is a nominal length of a piece of firewood for a standard wood stove.

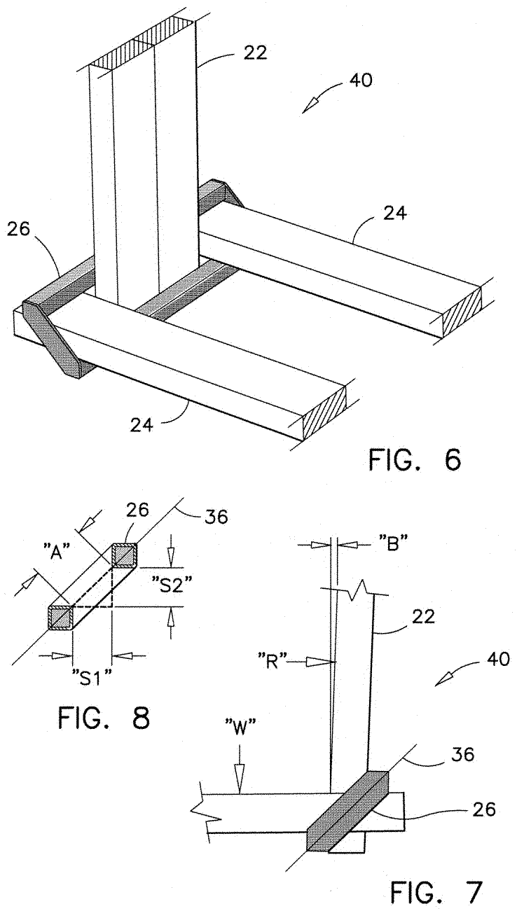

In use, the preferred firewood stack retainer 26 is placed to enclosed the end of rails 24 as illustrated in FIGS. 6 and 7. The retainer 26 is set to rest on the rails at a position where the plane 36 of the retainer 26 makes an angle of about 45° with the rails 24. As can also be seen, the rails 24 are set apart as far as possible inside the retainer 26, defining a cavity there between to receive two posts 22 side-by-side, as may be understood from FIG. 6. The posts 22 are inserted into the opening of the retainer 26 between the rails 24, and retained therein in a vertical position by locked-leverage action. In such a double lock-lever joint 40 the resistance “R” of the posts 26 is counteracted by the weight “W” of firewood sticks laid on the rails 24.

As mentioned before, the dimension “A” in FIG. 4 is equivalent to the hypotenuse of a right angle triangle with sides having the thickness of a 2×4 piece of lumber. However, the dimension “A” has a preferred value of the hypotenuse plus a relax tolerance. This relax tolerance allows for a lean-back position of the posts 22 as shown by dimension “B” in FIG. 7. This lean-back dimension “B” is preferably about 0.5 inches measured at two feet above the ground.

The lean-back dimension “B” is advantageous during the set up of the double lock-lever joint 40, as the posts 22 remain unsupported, in a vertical position prior to stacking sticks of firewood on the rails 24. In order to obtain this lean-back dimension “B”, the preferred dimension “A” as shown in FIG. 4 is the hypotenuse of a right angle triangle with sides “S1” and “S2” having the thickness of a rail 24 or post 22, plus a relax tolerance of +10-15% of this hypotenuse. When 2×4 lumber is used for the posts and rails, the dimension “A” is 2 5/16″ to 2 7/16″. Although this relax tolerance is advantageous, it is not necessary, as the lock-lever joint 40 with right angle alignment of the posts 22 to the rails 24 will retain a stack of firewood sticks in a neat and tidy arrangement.

What is claimed is:

1. A firewood stack retainer for use with standard 2×4 lumber stack posts and stack rails; comprising a stiff rectangular frame comprising two spaced-apart parallel longitudinal members and two spaced-apart parallel transverse members, said longitudinal members having a length similar to a width of a stack of firewood, and being spaced apart a distance equivalent to a hypotenuse of a right angle triangle with sides having a dimension equivalent to a thickness of standard 2×4 piece of lumber.

2. The firewood stack retainer as claimed in claim 1, wherein said distance is equivalent to said hypotenuse plus a relax tolerance of 10-15% of said hypotenuse.

3. The firewood stack retainer as claimed in claim 1, wherein said longitudinal members being made of square hollow structural steel and said transverse members being made of steel flat bars, and said longitudinal members being retained to said transverse members by welding.

4. The firewood stack retainer as claimed in claim 3 wherein diagonals of cross-sections of said longitudinal members aligning with each other in a same plane.

5. A double lock-lever joint between rails and posts of a firewood stack comprising a stiff rectangular frame retaining said rails and posts at an angle relative to each other; said rectangular frame comprising two spaced-apart parallel longitudinal members and two spaced-apart parallel transverse members, said longitudinal members having a length similar to a width of a stack of firewood, and being spaced apart a distance equivalent to a hypotenuse of a right angle triangle with sides having a thickness of one of said rails and said posts.

6. The double lock-lever joint as claimed in claim 5, wherein said angle is a right angle.

7. The double lock-lever joint as claimed in claim 5, wherein said distance is equivalent to said hypotenuse plus a relax tolerance of 10-15% of said hypotenuse.

8. The double lock-lever joint as claimed in claim 5, wherein said longitudinal members being made of square hollow structural steel and said transverse members being made of steel flat bars, and said longitudinal members being retained to said transverse members by welding.

9. The double lock-lever joint as claimed in claim 8, wherein diagonals of cross-sections of said longitudinal members aligning with each other in a same plane.

10. The double lock-lever joint as claimed in claim 5, wherein said rail and post comprising 2×4 standard lumber.

11. The double lock-lever joint as claimed in claim 9, wherein said plane extends at 45° from said rails.

12. A firewood stack comprising similar-dimensions rail and post and a stiff rectangular retainer retaining said rail and post into a lock-lever joint, at an angle relative to each other; said rectangular retainer comprising two spaced-apart parallel longitudinal members and two spaced-apart parallel transverse members, said longitudinal members having a length similar to a width of a stack of firewood, and being spaced apart a distance equivalent to a hypotenuse of a right angle triangle with sides having a thickness of one of said rail and said post.

13. The firewood stack retainer as claimed in claim 12, wherein said angle is a right angle.

14. The firewood stack retainer as claimed in claim 12, wherein said distance is equivalent to said hypotenuse plus a relax tolerance of 10-15% of said hypotenuse.

15. The firewood stack retainer as claimed in claim 12, wherein said longitudinal members being made of square hollow structural steel and said transverse members being made of steel flat bars, and said longitudinal members being retained to said transverse members by welding.

16. The firewood stack retainer as claimed in claim 12, wherein diagonals of cross-sections of said longitudinal members aligning with each other in a same plane.

17. The firewood stack retainer as claimed in claim 12, wherein said rail and post comprising 2×4 standard lumber.

18. The firewood stack as claimed in claim 16, wherein said plane extends at 45° from said rails.
